(19) United States
(12) Patent Application Publication
(10) Pub. No.: US 2022/0086011 A1
(43) Pub. Date: Mar. 17, 2022

(54) System, Methods and Apparatus to Quantify Efficacy of Transportation Systems and to Provide Electronic Warranty Certificate for Equipment and Manage Maintenance Contracts

(71) Applicant: Qirfiraz Ahmed Siddiqui, Castro Valley, CA (US)

(72) Inventors: Qirfiraz Siddiqui, Castro Valley, CA (US); Gilles Thierry de Bordeaux, Belmont, CA (US); Nanette Gill Rosen, San Francisco, CA (US)

(73) Assignee: Smart Bumper Sticker Inc, Castro Valley, CA (US)

(21) Appl. No.: 17/412,095

(22) Filed: Aug. 25, 2021

Related U.S. Application Data
(60) Provisional application No. 63/071,237, filed on Aug. 27, 2020.

(51) Int. Cl. H04L 9/32

(52) U.S. Cl. CPC H04L 9/3263; H04L 2209/38; H04L 9/3247

(57) ABSTRACT

Disclosed is a method of evaluating transportation handling conditions and events on packages, good and services, and providing an Electronic Warranty Certificate (EWC) to manage maintenance contracts, comprising of sensor modules equipped with MEMS and related micro-sensors, gathering vital data and securely logging characteristics into embedded memory modules suitably interfaced, offline or online, batch or real-time, with wired or wireless connections to centralized or localized databases providing custom programmed software producing dashboards, encrypted and secured by technology like Blockchain which distributes immutable/unchangeable information that can be verifiable without any trusted third-party, for operational and executive management services. The stored data is processed through Artificial Intelligence (AI) enabled deep-learning algorithms to predictively point out problem links in the transport chain network, so that remedial actions can be taken at the related nodes of the problem links.

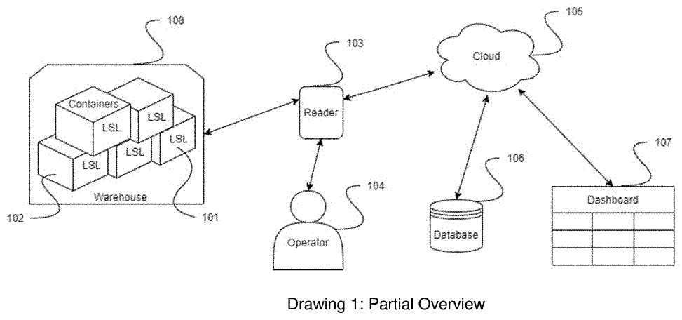

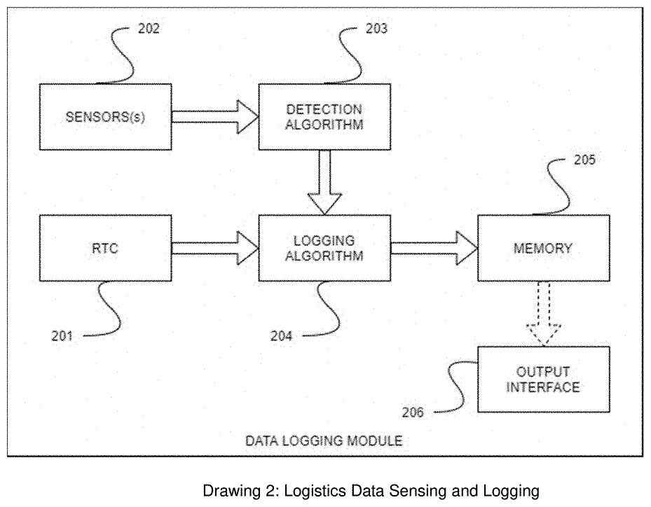

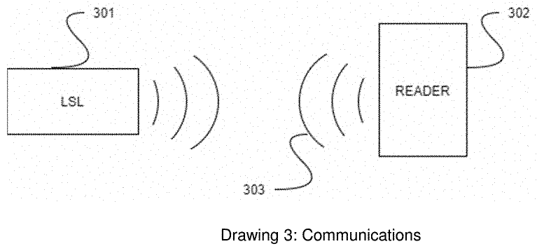

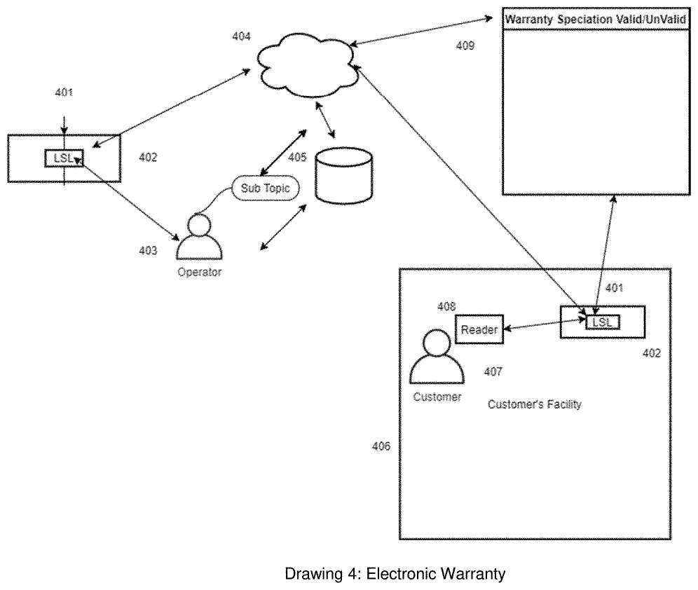

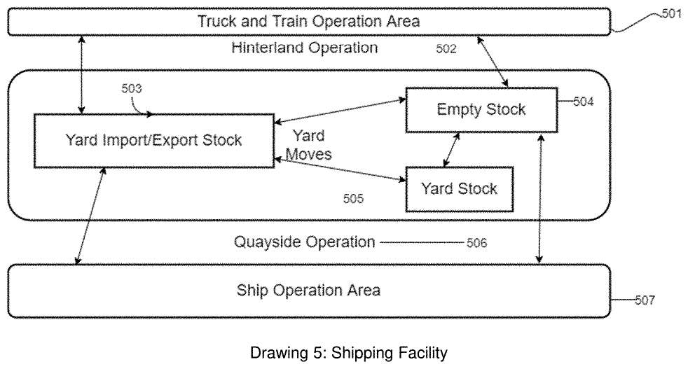

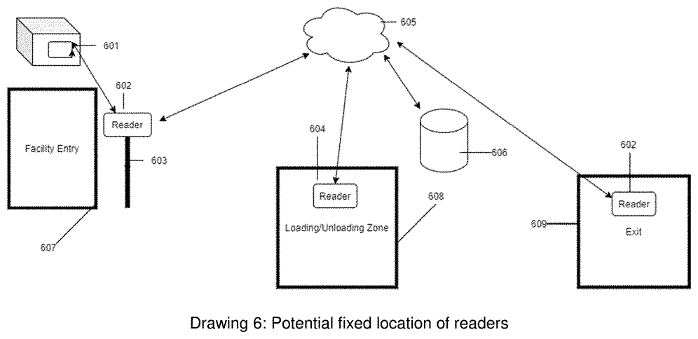

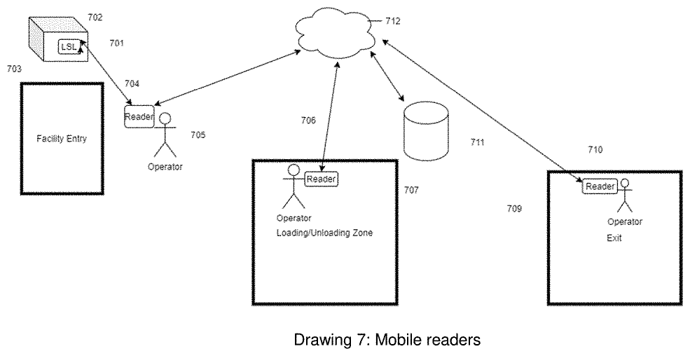

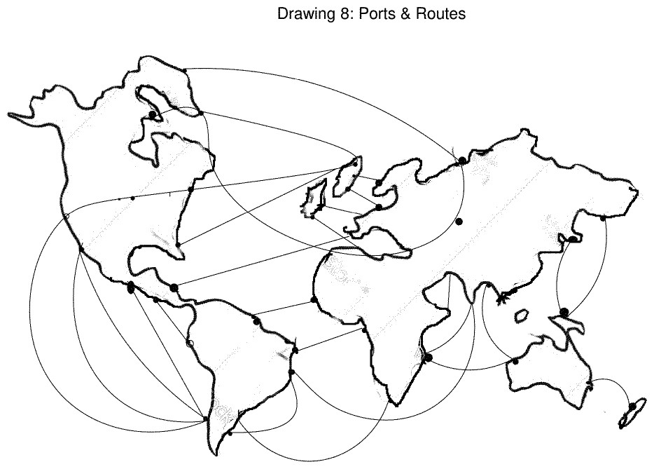

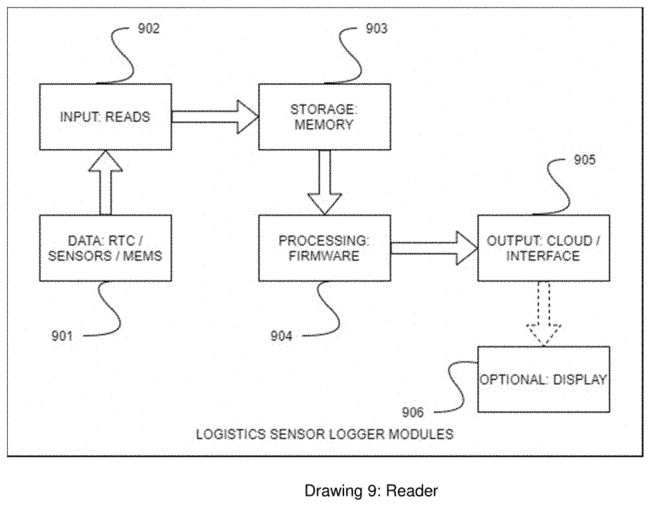

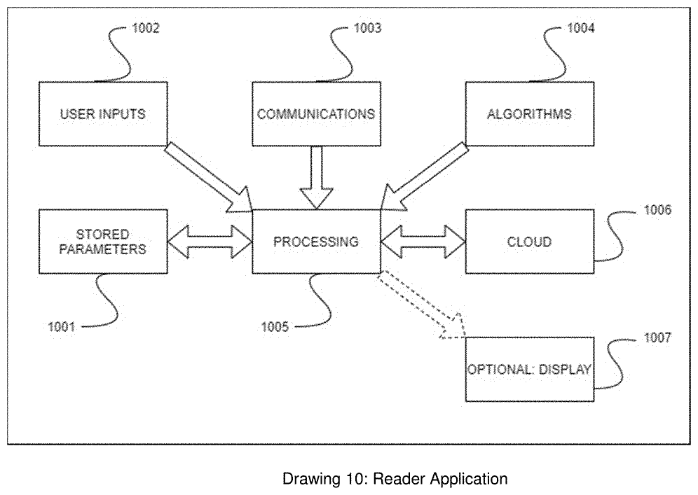

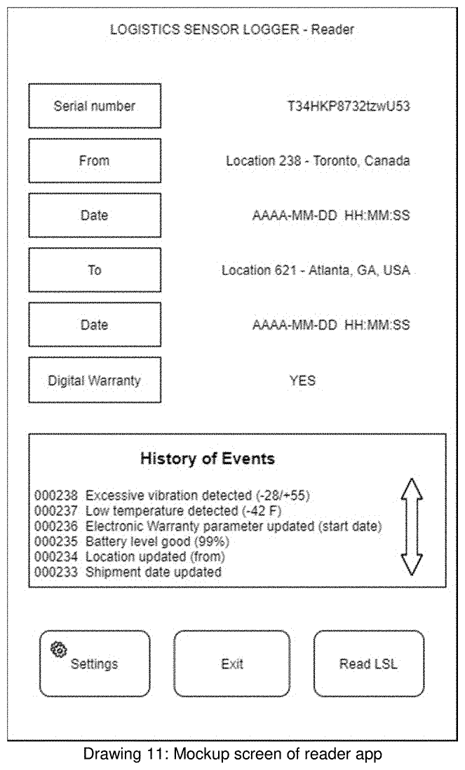

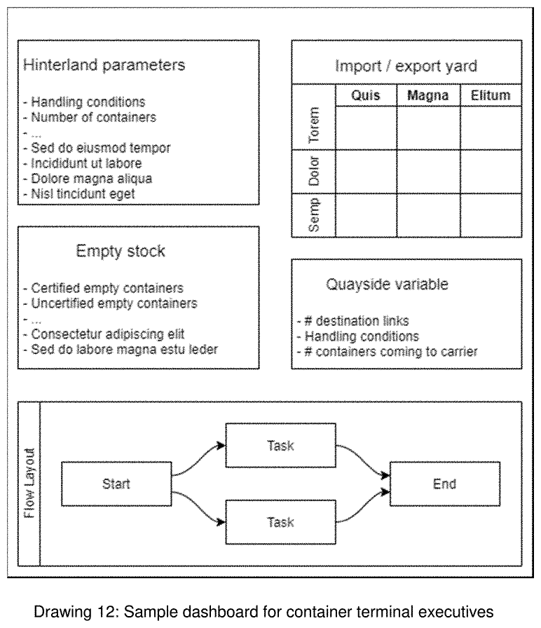

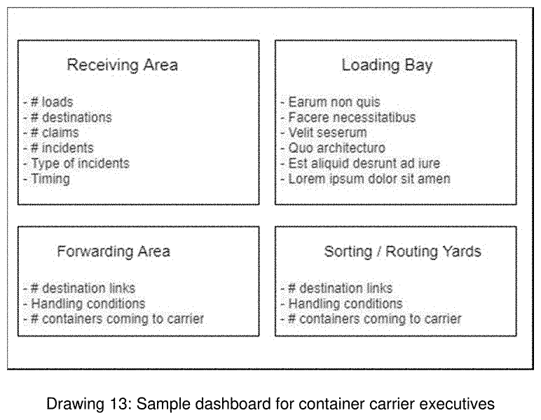

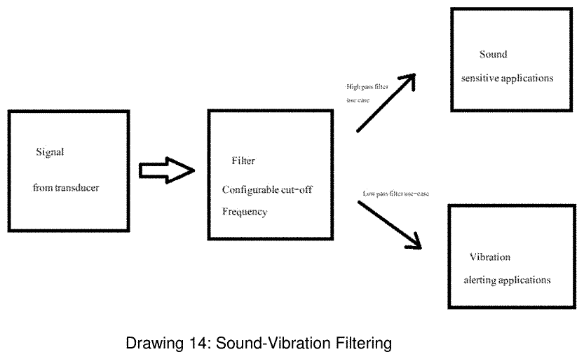

### PRIOR APPLICATION DATA

This application claims the priority of USPTO provisional patent application No. 63/071,237 filed on Aug. 27, 2020.

This above-mentioned priority application is based on previously filed USPTO Provisional Application No. 63/048,020 dated 3 Jul. 2020, and Provisional Patent Application No. 63/064,575 filed on 12 Aug. 2020.

All of the above-mentioned (3) provisional patent applications are included as a whole in this specification.

### BACKGROUND OF INVENTION

Undoubtedly, the world is becoming more of a global village where goods and services are transferred at huge distances, and the value of the goods and services is also increasing exponentially. At the same time, the Internet of Things (IoT) is taking over all aspects of human life. To get the best benefits from this advancement of interconnected technology, the digitization of logistic systems at macro and micro levels is required.

Equipment covered by a warranty previously relied on communication between a customer and a company that could involve multiple contacts and it is difficult to determine proof of damage. The discussion would rely on unverified reports or at the best a photograph. An Electronic Warranty Certificate (EWC) provides an accurate report of the extent of the damage, including the type of damage, incident location of damage, and the time of damage.

### Problem Statement

During transportation, goods and packages get mishandled and damaged. Damages can still occur even after a customer takes possession of it: including how the customer uses and stores the equipment. LSL can review that data which can be used to determine if the warranty is still valid.

Reasons for Damage include:
Bottlenecks at the manual entry point of data,
Erroneous data,
Delayed entry of data,
Lost data,
Lack of accuracy due to visual/manual inspection of delivered goods,
Hidden damages,
Determination of responsible parties for long haul multimodal transportation,
Difficulties to analyze data,
Certification of the time and point of origin of damage
Improper storage by customer after receiving equipment
After the product is delivered damage can still occur.
Poor handling of equipment by customer
Viotating product specifications
Issues manually collecting and transmitting equipment details (model number, serial number, date of purchase, maintenance contract number, warranty status.)

Transportation concerns have been raised for genetically sensitive medicine/material which may include RNA vaccines and other sensitive devices. A quick search on the Internet about radiation effects and RNA relationship to the vaccines releases the following information:

https://www.cdc.gov/coronavirus/2019-ncov/vaccines/different-vaccines/mrna.html

What You Need to Know?

mRNA vaccines are a new type of vaccine to protect against infectious diseases.

mRNA vaccines teach our cells how to make a protein—or even just a piece of a protein—that triggers an immune response inside our bodies. The benefit of mRNA vaccines, like all vaccines, is that those vaccinated gain protection without ever having to risk the serious consequences of getting sick with COVID-19.

https://www.ncbi.nlm.nih.gov/pmc/articles/PMC2656420/

What can damage RNA?

“RNA under attack: Cellular handling of RNA damage”

Damage to RNA from ultraviolet light, oxidation, chlorination, nitration, and akylation can include chemical modifications to nucleobases as well as RNA-RNA and RNA-protein crosslinking.

https://link.springer.com/article/10.1007/s11434-011-4721-7#Abs1

“A novel method for ionizing radiation-induced RNA damage detection by poly(A)-tailing RT-PCR”

Ionizing radiation (IR) causes severe cellular damage both directly and indirectly and disrupts RNA integrity. RNA strand breaks are the most frequent type of damage caused by IR. RNA damage is involved in the development of degenerative diseases, including Alzheimer's disease and Parkinson's disease. However, the mechanism of mRNA damage and any resulting pathophysiological outcomes are poorly understood. This is partly because there is a lack of sensitive tools to monitor damage randomly occurring in RNA, especially RNA strand break damage in a given RNA.

### BRIEF SUMMARY OF THE INVENTION

Our real-time reporting solution enables dynamic monitoring of status and risk conditions: using Big Data, Blockchain and Artificial Intelligence (AI), transforming the logistics industry by providing additional functionalities and information over existing systems.

Our innovative high-tech approach uses Near-Field-Communication (NFC) technology, proven, secure, accurate, low-power consumption, allowing our device to last up to 5 years without recharging. Data-retrieval is achieved wirelessly using inexpensive mobile devices such as smartphones or dedicated off-the-shelf small handheld NFC readers.

Using predictive location tracking algorithms, we pinpoint the reason, place and moment of damage to the shipment, without relying on GPS equipment, saving power and preventing spoofing attack risks. Our secure, accurate, immutable data help quickly resolve insurance and responsibility disputes.

An “ Electronic Warranty Certificate (EWC)” manages identifies when damage occurs and is used in maintenance contracts, consisting of sensor modules equipped with MEMS and related micro-sensors, gathering vital data and securely logging characteristics into embedded memory modules suitably interfaced, offline or online, secured by Blockchain technology or comparable technologies, processed through Artificial Intelligence (AI) enabled deep-learning algorithms to predictively point out problem links in the transport chain network.

In short, our dashboard provides comprehensive reports on the health of a logistics/transportation system, from small packages of a few pounds to large carriers weighing hundreds of tons. Our flexible line of products works with any type of logistics transportation methods (ship/train/truck/planes).

Our solution can be used equally well, in offline-batch or in real-time modes, with wired or wireless connections to centralized or localized databases providing custom programmed software producing dashboards, optionally encrypted and secured by Blockchain technology, or by Non-FungibleToken (NFT) technology, for operational and executive management services. The stored data is processed through Artificial intelligence (AI) enabled deep-learning algorithms to predictively point out problem links in the transport chain network, so that remedial actions can be taken at the related nodes of the problem links.

### BRIEF DESCRIPTION OF DRAWINGS

See drawing 1: Partial Overview

Solution proposed in our invention is described in drawing 1, whereby a system requires to electronically monitor and log vital state variables and state change events and information that occur during the transportation of cargo, using state-of-the-art modern technology involving inexpensive sensor devices embedded at every node of the system.
The supply chain can have warehouses [108] located anywhere. These locations may include: Quayside, Hinterland, or any other location.
LSL [101] can be activated at any time during the process. Typically, it is done at the origination point, and can also be initialized en-route to its destination.
Operators [104] include gatekeepers, maintenance operators, shipping and handling personnel, insurance claim adjusters, supervisors, management, any authorized personnel. Operator interacts with LSL [101] using the reader [103] to initialize it, to calibrate it, or to retrieve data.
Containers [102] consist of many types and sizes of cargo and packages, of any weight and material, which protect items in transit. Containers can be moved from the warehouse [108] in several ways: including air, maritime, overland and underground transportation.
The container [102] has an attached activated LSL [101].
The operator [104] reads data using a reader [103] when appropriate.
Cloud [105] is one medium transmitting and/or storing the data between entities.
A database [106] (dynamic/batch/synchronous or asynchronous) is a tool used to store data.
After recording the data, LSL [101] can send the event log [106].
Authorized users with access rights can view the dashboard [107] which displays the data. For example, these people could be but are not limited to supervisors, management, insurance companies, etc.
Dashboard [107] and database [106]:
   Provide centralization of data in database [106] to help analyze and report problem routes and nodes resulting in quick fixing of actual and potential issues
   Aid in reporting and identifying problems using dashboards [107] which can include updating in real-time.
   Notifications can be delivered in a variety of formats, including but not limited to dashboard [107], emails, text and voice.

Our real-time reporting solution enables dynamic monitoring of status and risk conditions: using Big Data, Blockchain and Artificial Intelligence (AI), transforming the logistics industry by providing additional functionalities and information over existing systems.

We use our proprietary technology to geolocate WITHOUT the help of GPS technology, so we do NOT rely on GPS to get geolocation. We use “Deep Learning Neural Network” (ML+AI) to precisely estimate geolocation. This is part of our invented/patented proprietary technology. No competitor and no other product have this technology.

We use energy-harvesting as an additional source of power, thereby extending the battery life to over 5 years without the need for charging.

Our LSL devices are field-programmable. We use NFC technology to reconfigure LSL wirelessly (our competition uses USB/wired interface.

Our LSL devices are secure. We use encryption and rely on Blockchain technology to preserve data integrity, authenticity, and make our data immutable and trusted.

See drawing 2: Logistics Data Sensing and Logging

The LSL [101] is comprised of:
A real-time clock[201] keeping accurate time of events.
Sensors [202] dedicated to detecting various monitoring requirements.
Algorithms [203] adjusting and manipulating Sensor [202] data and timing [201] to raise events and alerts.
A logging mechanism [204] to keep track of events.
Memory [205] in operation of the board.
Optional display [206] of data and information.

See drawing 3: Communications

Brief description of drawing:
LSL [301]. Same as [101]
Reader [302] is any device that can access LSL [301] data, including but not limited to smartphone, tablet, electronic device, etc. Same as [103]
Communication [303] between LSL [301] and the reader [302]. It could be, but is not limited to, NFC, Wi-Fi, Zigbee, RFID, etc.

See drawing 4: Electronic Warranty

Brief description of drawing:
Equipment [401] that is going to receive or is covered under warranty
Activated LSL [402] with a warranty specification, that is attached to the equipment
Operator [403] is the person who activates the LSL with a warranty and attaches it to the equipment
Cloud [404] is the medium moving the data between entities
Database [405] stores the data
Customer facility [406] is the location where the warrantied equipment is stationed
Customer [407] can monitor the equipment
Reader [408] is used to collect data from and send data to LSL [402], and transmit data to the cloud [404] and database [405]
Warranty [409] contains the specifications of the digital warranty and will indicate if the equipment is covered or in violation of the specifications of the warranty

See drawing 5: Shipping Facility

This diagram is a typical representation of a logistics operation in a shipping facility which has the following components:
Truck and train operations area [501] is where logistics operators enter the shipping facility and shipments are dispatched for distribution
Hinterland operation [502] is the logistics operations taking place in the area [501]
Quayside operations [506] are logistics operations happening in the shipping operations area
Logistics operators[507] exit through the outland area [507]
Yard stock [503] is the area for the existing stock and for the expected stock
Empty stock [504] is an area holding containers that are either emptied or waiting to be filled
Sheds [505] is an area holding containers being repaired or waiting for repair

See drawing 6: Potential fixed location of readers

In order to effectively monitor logistics operations, following readers may be required at several fixed locations similar to the reader mounting systems and locations mentioned below:
LSL [601] on a container
Reader [602] at a fixed location on a pole
Reader [603] at a fixed location on a wall or ceiling or table
Reader [604] at a fixed location on the ground
Cloud [605]
Database [606]
Facility Entry [607] can be either at the Hinterland Operations [502] or at the Quayside Operations [506].
Loading and unloading zones [608]. This reader can be at any loading and unloading zones in the areas of Yard Stock [503] or Empty Stock [504] or Repair and Maintenance Sheds [505].
Facility Exit [609] can be either at Hinterland Operations [502] or at the Quayside Operations [506].

See drawing 7: Mobile readers

Brief description of drawing:
Container [701] arriving at logistic facility
LSL [702] is attached to container and activated if is was not active prior to attachment
Facility [703] entry point
Mobile Reader [704] at entry point (Mobile Reader can be used anywhere)
Operator [705] (Operator can be anywhere)
Mobile reader [706] at loading/unloading zone (Mobile Reader can be used anywhere)
Loading/unloading zone [707]
Operator [708] (Operator can be anywhere)
Exit point [709]
Mobile reader [710] at Exit point (Mobile Reader can be used anywhere)
Database [711] same as [106]
Cloud [712] same as [105]
Operator [713] (Operator can be anywhere)

See drawing 8: Ports

Brief description of drawing:
[801] ports & connecting routes

See drawing 9: Reader

Brief description of drawing:
Onboard electronic and software elements [901], including but not limited to Real-Time-Clock, sensors, MEMS, etc.
Data input and data entry [902]
Temporary or permanent memory [903] inside the reader
Firmware or software [904] driving the reader's behavior and operations
Output interface [905]
Optional interface/display [906], such as, but not limited to, display, lights, voice, haptic, smell, actuators, etc.

See drawing 10: Reader Application

The Reader Application is a software system that can process and/or display data. It runs algorithms and is also commonly called app or application. It can be on a phone, on a tablet, on a computer, and generally on any device capable of electronically processing, storing and/or displaying data and results, able to communicate with other devices.

Brief description of drawing:
Stored Parameters [1001] holding basic configuration of the reader
User Inputs [1002] are manual or automatic entry of data
Communication between LSL and reader [1003]. It could be, but is not limited to, NFC, Wi-Fi, Zigbee, RFID, etc. Same as [303]
Algorithms [1004] are any arrangement of steps defining logic rules applied by the application
Processing [1005] is number and data crunching
Cloud [1006] is same as [105]
Optional display [1007] is same as [906]

See drawing 11: Mockup screen of reader app.

See drawing 12: Sample dashboard for container terminal executives.

See drawing 13: Sample dashboard for container carrier executives.

See drawing 14: Sound-Vibration Filtering.

### DETAILED DESCRIPTION OF THE INVENTION

Specifically for transportation of genetically-sensitive material, our invention offers a novel way to identify routes that have damaging conditions with the potential to disrupt genetic material. There is currently a lack of tools, as mentioned in Chinese Science Bulletin “A novel method for ionizing radiation-induced RNA damage detection by poly(A)-tailing RT-PCR” at https://link.springer.com/article/10.1007/s11434-011-4721-7#Abs1 to detect these damaging conditions. Our invention not only detects but could be used to prevent sensitive material going into problem or risk areas.

### Embodiment 1

### Use Case: Equipment Manufacturers

Abbreviations
IoT—Internet of Things
NFC—Near Field Communication
EM—Equipment Manufacturer
LSL—Logistics Sensor Logger
SC—Sending Customer (customer of the trucking company shipping cargo to a Receiving Customer)
RC—Receiving customer (customer receiving the cargo sent by SC)
Label—shipping information used to process cargo

Target
Companies concerned with cargo damage during shipment (EM)

Standard operating procedure
1. (action) EM attaches the LSL to the equipment.
2. (action) EM scans the LSL device with an LSL reader.
3. (action) EM sets parameters for warranty if needed (detailed description in the Digital Warranty embodiment).
4. (action) EM attaches the LSL to the equipment.
5. (action) EM optionally creates a label. The label could be any type of label, including but not limited to a barcode. The label's information goes into the app.
6. (action) EM has the option to put a digital warranty certificate on LSL.
7. (information) EM activates the warranty if needed.
8. (information) The LSL device must remain attached to the container until the cargo is delivered, for the warranty to be valid.
9. (action) At the receiving end RC scans LSL and sends electronically collected information and/or logged data to EM and/or to the authorized network/database.
10. (information) The LSL remains attached to the equipment as a digital warranty certificate for retrieving any warranty information. The warranty is void if the device is detached from the equipment or is modified.

### Embodiment 2

### Use Case: Trucking Companies

Abbreviations
IoT—Internet of Things
NFC—Near Field Communication
TC—Trucking Company
LSL—Logistics Sensor Logger
SC—Sending Customer (customer of the trucking company shipping cargo to a Receiving Customer)
RC—Receiving customer (customer receiving the cargo sent by SC)
Label—shipping information used to process cargo

Target:
A trucking company is hired by a shipper who wants to move goods from one place to another. A shipper can be an agricultural producer, farm owner, importer of goods, exporter of goods, or any other type of big, medium or small business.
Reports can be generated about individual containers as well as overall health & safety standards of the whole logistic system. In case of damages, the same centralized database can be used to investigate insurance claims.
LSL is used to monitor the safe and timely transportation of cargo.
Logistic Sensor Logger (LSL) is a credit-card-size IoT device, for shipment tracking. With the help of configurable microelectronic sensors, LSL continuously records shocks, hits and temperature of the shipped cargo.
Through NFC or any other electronic data transmission interface, the recorded data is seamlessly transferred to a reader app which can give instantaneous feedback. The data from the reader app can also be easily integrated into any ERP program like SAP or Salesforce, etc.
In addition to shocks, vibration and temperature, LSL can be customized to measure other variables like humidity, barometric pressure, etc.
LSL is a low-power, plug-and-play device which can be powered using energy harvesting techniques.

Standard operating procedure
1. (action) TC attaches the LSL to the container.
2. (action) TC scans the LSL device with an LSL reader.
3. (action) TC sets parameters for warranty if needed (detailed description in the Digital Warranty embodiment).
4. (action) TC attaches the LSL to the container.
5. (action) TC optionally creates a label. The label could be any type of label, including but not limited to a barcode. The label's information goes into the app.
6. (action) TC has the option to put a digital warranty certificate on LSL.
7. (information) Shipping information is sent to SC and/or RC.
8. (information) The SC sends the scanned information to TC to activate the warranty if needed.
9. (information) The LSL device must remain attached to the container until the cargo is delivered, for the warranty to be valid.
10. (action) At the receiving end RC scans LSL and sends electronically collected information and/or logged data to the authorized network/database.
11. (information) The LSL remains attached to the container as a digital warranty certificate. The warranty is void if the device is detached from the container or is modified.

### Embodiment 3

### Companies Operating Container Terminals

Abbreviations
IoT—Internet of Things
NFC—Near Field Communication
EM—Equipment Manufacturer
LSL—Logistics Sensor Logger
SC—Sending Customer (customer of the trucking company shipping cargo to a Receiving Customer)
RC—Receiving customer (customer receiving the cargo sent by SC)
Label—shipping information used to process cargo
TC—Trucking Company
COCT—Company-Operated Container Terminal
BL—Bill of lading

Target
Companies operating container terminals concerned with damage to cargo during shipment or at rest. It is important, so they are not held liable for damages that occur outside of their custody of the containers.

Standard operating procedure
1. (action) COOT has gathered all the information needed and will initialize the container information (e.g. ID# of the container and route description with origin destination). This information is typically contained in BL.
2. (action) COOT properly mounts the LSL device and activates it.
3. (action) All of the necessary information is transferred to an LSL.
4. (action) The activation of LSL is provided via any communication means available, including but not limited to NFC, using a LSL app installed on a reader.
5. (action) The container leaves the Facility. At the gate or any chosen location by the COCT, the container is scanned via a LSL reader.
6. (action) The container is shipped to its destination. During transportation, the LSL device keeps on logging according to the parameters previously set by the COCT.
7. (action) During transportation, the LSL attached to the container can be scanned again via the reader if deemed necessary or if it is part of the process.
8. (action) Upon container arrival to the destination facility (at the gate or at any chosen location by the COCT), the container is scanned via a LSL reader.
9. (action) At their predetermined terminal location of shipment, the LSL is scanned via the reader, so the customer and the COCT can access a full range of log data.
10. (action) The LSL device may stay attached to the container for future use, or be removed and reused as necessary.

1) An embodiment of Sensing Devices in our Solution

Logistic Sensor Logger is an IoT device, for fragile shipment tracking. Thanks to configurable microelectronic sensors, LSL continuously records shocks, hits, and temperature of the shipped cargo.
Through NFC (Near Field Communications) interface, the recorded data is seamlessly transferred to a smartphone app which gives an instantaneous graphical report, and the data from the smartphone app can be easily integrated into your ERP program like SAP, Oracle, Salesforce, Microsoft Dynamics, etc.
An ideal use-case for LSL is on large shipping containers, where the Logistic Sensor Logger uses a unique ID to monitor shock-levels of each and every container in the logistic system. Using a smartphone app (or by using an inexpensive NFC reader) the data from each container is transferred to a centralized back-end database on enterprise servers where reports are generated about individual containers as well as over-all health & safety standards of the whole logistic system. In case of damages, the same centralized database can be used to investigate insurance claims.
In addition to shocks/vibration and temperature, LSL can be customized to measure other variables like humidity, barometric pressure, etc.
LSL is a cost effective, plug-and-play device with fast installation. The accompanying Smartphone application and back-end software are provided for free with the bulk purchase.
The extremely low-power design of LSL, makes a thin “coin-cell” battery last for 3 years and is supported by a warranty.

2) An Embodiment of a Sample User Interface of Reader Device (Smartphone, dedicated device, etc.)
A smartphone application is used to interact with the Logistic Sensor Logger device.
See drawing 11: Mockup screen of reader app

3) Use Cases of Several Different Sensing Devices in our Solution

Security Embodiment

Logistic sensor logging device (LSL) can be implemented as a theft monitoring system with the help of appropriately programmed firmware and/or additional sensors/input transducers. It will monitor vibrations of attempted break ins.

Since LSL constantly monitors the surface it is attached to, an accurate time stamp is available of when the theft attempt occurs.

More complex LSL devices could use additional sensors such as light, humidity, or other environmental changes.

Sound and vibration are closely related signals and in most sensing devices treat them as the same. However, for the purpose of this invention, a sound can be transmitted through air and detected by a transducer while a vibration is transmitted through the surface and/or core of a body and detected by a transducer.

A low-pass filter using electronic circuitry and/or using software algorithms for frequency filtering or any other filtering technique is used to separate the relevant signal from the noise.

See drawing 14: Sound-Vibration Filtering

Humidity: The device allows detection of humidity levels outside of an accepted range of values, and logs alerts,

Shipped items sensitive to the level of humidity need humidity-level detection. Some examples are food like strawberries which need some humidity to stay fresh and not get dehydrated while some crispy food items or paper products may become unusable with excessive humidity. Some high-value items like delicate art can be damaged and/or lose value if exposed to unfavorable humidity conditions. Above all, transportation of medicinal remedies are becoming increasingly popular amongst overseas communities, specifically plant- or animal-based traditional products that can deteriorate under adverse conditions.

Equipment can also be vulnerable to unfavorable humidity conditions. Outcomes can include rust, water behind screens, bubbles, electrical shorts, and mold amongst others.

Light: For non-security applications, it may be useful to know if an object has been exposed to too-much or to not-enough light, either instantly or as a continuum. For example, sensitive photographic supplies must be kept in light-controlled places, textile and paintings may experience a change of colors.

For security use cases, knowing when a container is opened or not opened can trigger a light level event that may include a timestamp,

Temperature sensing: Due to global warming, certain established infrastructure are not designed for the new temperature ranges. This invention can be used to monitor medications and can alert providers if the medication has been exposed to temperatures outside a specified range. Other usages include food, materials, equipment or any other application, where accepted temperature ranges are necessary.

Radiation Dosimetry: Using the right transducer, our invention can monitor and alert when radiation levels exceed certain ranges. Being able to monitor radiation may reduce legal issues. Many locations restrict the levels of radiation in their areas. Such examples can be city municipalities like Berkeley or locations that restrict the location and number of cell phone towers. Our invention allows carriers the ability to monitor radiation levels and abide by local restrictions.

Additional concerns can involve genetic/biological modifications caused by exposure to radiations. Often, when these exposures are suspected to have occurred, lawsuits can follow. Our invention provides an accurate log of levels of exposure and can be used in these lawsuits. Besides the legal issues, our invention will definitely help safeguard the transportation of genetically-sensitive live items to keep them unchanged for healthy and environment-friendly utilisation.

In the pos-COVID-19 era, a new category of medicine has been developed which purposely modifies living cells' structures.

Magnetism:

In the age of nano-material and quantum computing, even a milligauss (mG) of magnetism can cause serious adverse effects, resulting in complete malfunction. Everyday items like cell phones, credit cards, memory cards, transit tickets and other magnetic items are destroyed by exposure to excessive magnetic fields which can destroy their data. With our invention, all of this can be traced and subsequently prevented.

An accurate time stamp from LSL will help investigations by the police, insurance companies and the carrier company. Since the carrier knows where a shipment is based on time, it is clear when and where the event happened.

Tracking these events can help find problem areas, or less secure transportation equipment. To the executives of a variety of companies this will streamline and reduce costs within the company.

In addition to logging break-in events, it can initiate an alarm: either audio/video, non noticeable alerts such as: email, text, or any additional notification procedure depending on the best practices of the company.

Additional Sensors we can use include sound and other sensory devices.

See drawing 5: Shipping Facility

Dashboard number 1 for Terminal Executive (Includes but not limited to):
Handling conditions at hinterland operation
Handling conditions at quayside operation
Handling conditions at empty stock area
Handling conditions at import/export yard
Handling conditions at sheds
Number of containers at a particular time in the above-mentioned areas
Number of containers leaving quayside operation area
Number of containers leaving hinterland operation area
Number of destination links at the hinterland node
Number of destination links at the quayside node
Number of carriers on each link
Number of loads on each link
Insured freight values on each link
Insurance claims on each link
Insurance claims segregated by carrier
Number and types of incidents on each link
Number and types of incidents aggregated by carrier on each link

See drawing 12: Sample dashboard for container terminal executives

Dashboard number 2 for Carrier Executive (Includes but not limited to):

Handling conditions at hinterland operation
Handling conditions at quayside operation
Number of containers coming to carrier at the hinterland operation area
Number of containers coming to carrier at the quayside operation area
Number of destination links at the hinterland node
Number of destination links at the quayside node
Number of loads on each link for this carrier
Insured freight values on each link for this carrier
Insurance claims on each link for this carrier
Number and types of incidents on each link
Number and types of incidents for this carrier on each link

See drawing 13: Sample dashboard for container carrier executives

Dashboard number 3 for Shipper/Manufacturer Executive (Includes but not limited to):
Number of clients per destination
Number of carriers per destination
Number of packages per carrier
Value of packages per carrier
Insurance claims per carrier
Insurance claims per destination
Number of insurance claims per client
Origin/destination of individual packages and related handling data

Component List of the System

The following are the hardware, software, and operational components which are combined in various configurations to produce different embodiments of our invention:

Data Acquisition Events
Within the terminal:
   Each container must be initialized at empty stock areas
   The back-end database of carriers and containers is updated
   Import/export yards initializes the LSL with origin, destination and carrier information
   Containers/LSL are scanned at quayside and hinderland areas as they are transported
   As the containers are moved to the shed areas for repair or maintenance, LSL is scanned and the database is updated

List of Data Acquisition Points
Shipper/manufacturer initialize the LSL
Carrier pick up the package
Container terminal entry point
Internally at empty stock areas, import/export yards, sheds, exit points, whenever the freight is moved from one place to another
Final scanning at the destination

List of Data Acquisition Devices
Smartphone or reader
Smartphone application
Handheld mobile reader
Fixed reader at appropriate locations in the container terminal facility
Manual initialization of LSL
LSL reading/writing/updating at any transit point
Manual computer entry (as a last resort)

### Embodiment 4

### Use Case: Courier Companies

Abbreviations
IoT—Internet of Things
NFC—Near Field Communication
EM—Equipment Manufacturer
LSL—Logistics Sensor Logger
SC—Sending Customer (customer of the trucking company shipping cargo to a Receiving Customer)
RC—Receiving customer (customer receiving the cargo sent by SC)
Label—shipping information used to process cargo
TC—Trucking Company
CC—Courier company
BL (bill of lading)

Target
Companies concerned with cargo damage during shipment (CC)

Standard operating procedure
1. (action) The CC creates their own label with the necessary data to manage the shipment.
2. (action) The CC activates the LSL device with the necessary data.
3. (action) The CC attaches LSL to the package.
4. (action) The activation of LSL is provided via any communication means available, including but not limited to NFC, using a LSL app installed on a reader.
5. (action) The package leaves the CC's facility. At the gate or any chosen location by the CC, the package is scanned via a LSL reader.
6. (action) The package is shipped to its destination. During transportation, the LSL device keeps on logging according to the parameters previously set by the CC.
7. (action) During transportation, the LSL attached to the container can be scanned again via the reader if deemed necessary or if it is part of the process.
8. (action) At their predetermined terminal location of shipment, the LSL is scanned via the reader, so the CC can access a full range of log data.
9. (action) The CC can decide how much of the LSL data to share with the customer.
10. (action) Reverse logistics means the CC operator (driver of the vehicle that provided the shipment of the package with LSL) unmounts the LSL device and returns it to the central location (CC owner). Another option is that the LSL may be discarded if the CC does not wish to reuse it.

### Embodiment 5

### Use Case: Large Companies

Abbreviations
IoT—Internet of Things
NFC—Near Field Communication
EM—Equipment Manufacturer
LSL—Logistics Sensor Logger
SC—Sending Customer (customer of the trucking company shipping cargo to a Receiving Customer)
RC—Receiving customer (customer receiving the cargo sent by SC)
Label—shipping information used to process cargo
TC—Trucking Company
CC—Courier company
BL—Bill of Lading
LC—Large Company

Target
Large companies that wish to track their shipments internally. They may use their own employees to transport the shipment, or they may contract a third party shipper.

Standard operating procedure
1. (action) The LC creates their own label with the necessary data to manage the shipment.
2. (action) The LC activates the LSL device with the necessary data.
3. (action) The LC attaches LSL to the package.
4. (action) The activation of LSL is provided via any communication means available, including but not limited to NFC, using a LSL app installed on a reader.
5. (action) The LC begins the shipment process, either with their own employees, or using a third-party CC. The package leaves the CC's facility.
6. (action) The package is shipped to its destination. During transportation, the LSL device keeps on logging according to the parameters previously set by the LC.
7. (action) At their predetermined terminal location of shipment, the LSL is scanned via the reader, so the LC can access a full range of log data.
8. (action) Reverse logistics means the LC unmounts the LSL device and returns it to a central location (LC shipping department). Another option is that the LSL may be discarded if the LC does not wish to reuse it.

### Embodiment 6

### Use Case: Small End-Users

Abbreviations
IoT—Internet of Things
NFC—Near Field Communication
EM—Equipment Manufacturer
LSL—Logistics Sensor Logger
SC—Sending Customer (customer of the trucking company shipping cargo to a Receiving Customer)
RC—Receiving customer (customer receiving the cargo sent by SC)
Label—shipping information used to process cargo
TC—Trucking Company
CC—Courier company
BL—Bill of Lading
LC—Large Company
SE—Small End-User

Target
Small end-users that wish to ship products that are fragile and could be damaged during shipment. The SEU will often utilize a third-party courier company to ship their products.

Standard operating procedure
1. (action) The SE enters the specifications they select about damage thresholds. The SE activates these parameters on the LSL using a reader.
2. (action) The SE attaches the activated LSL to the package.
3. (action) The SE hands off the package to the courier company. The LSL device logs all activity.
4. (action) The SE customer receives the package from the courier company.
5. (action) The SE customer uses the LSL app on a reader to evaluate the shipping conditions and to report the status back to the SE.
6. (action) Reverse logistics option consists of the SE customer sending back the LSL device to the SE or discarding the LSL if allowed.
7. (action) Upon receiving the LSL device, the SE can clear and reuse the device.

### Embodiment 7

### Use Case: Container-Manufacturer/Leasing/Owner

Companies Ask Qirifirz what this is. Is it container companies adding to the container as part of a service? Q confirms it is attached or built in LSL to container. Still need to edit it NOte emphasis nobody does this Add to abstract!!!!!!

Abbreviations
IoT—Internet of Things
NFC—Near Field Communication
EM—Equipment Manufacturer
LSL—Logistics Sensor Logger
SC—Sending Customer (customer of the trucking company shipping cargo to a Receiving Customer)
RC—Receiving customer (customer receiving the cargo sent by SC)
Label—shipping information used to process cargo
TC—Trucking Company
CC—Courier company
BL—Bill of Lading
LC—Large Company
SE—Small End-User
CNTC—Container-Manufacturer/Leasing/Owner company
SBS—Smart Bumper
SEU—shipping end user
SEC—Shipping end customer

Target
Container companies (CNTC) like Adrian Maersk, Hapag-Lloyd, etc.

Standard operating procedure
1. (action) LSL devices leave an SBS company as an ordered product (including protective packaging, 5 sleeves for every LSL, 10/50/100/1000 pieces of LSL, operation manual)
2. (requirement) SBS company provides specific instructions why and where the CNTC is required to put the LSL device.
3. (document) SBS provides best practices how to mount the LSL device onto the CNTC package
4. (action) CNTC initializes the container information (e.g. ID# of the container and route description with origin destination. All this info is contained in BL (bill of lading).
5. (action) CNTC mounts properly LSL device and activates it according to document in step #3 at the time when they have physical contact over a package.
6. (action) The activation of LSL is provided via NFC by an LSL app installed on a smartphone.
7. (action) The container leaves the facility and at the gate of the facility all the containers are scanned via NFC app.
8. (information) Then it is shipped to the destination while the LSL device keeps on logging according to the parameters set in step 5.
9. (action) At the destination facility (at the gate) the container is scanned again via NFC app.
10. (action) After the container is being reloaded to the truck, it is scanned again via NFC app (so the customer gets a full range of log data).
11. (action) Final scanning is provided at the final destination by the end user.
12. (information) The LSL device stays with a container for further travels and data logging.
13. (action) CNTC gets the LSL device log and may decide which recipients are a target of the logged information.

### Embodiment 8

### Executive Dashboard

Abbreviations
BL—Bill of Lading
CC—Courier company
CEW—Certified Electronic Warranty
CNTC—Container-Manufacturer/Leasing/Owner company
ED—Executive Dashboard
IEM—Equipment Manufacturer
IoT—Internet of Things
LSL—Logistics Sensor Logger
Label—shipping information used to process cargo
LC—Large Company
NFC—Near Field Communication
RC—Receiving customer (customer receiving the cargo sent by SC)
SBS—Smart Bumper Sticker
SC—Sending Customer (customer of the trucking company shipping cargo to a Receiving Customer)
SE—Small End-User
SEU—shipping end user
SEC—Shipping end customer
TC—Trucking Company
The executive dashboard is a general information framework for decision makers in embodiments 1 (Equipment Manufacturers), 2 (Trucking Companies), 3 (Companies Operating Container Terminals) and 4 (Courier Companies).
The dashboard assists decision makers in providing a global view of their operations in order to make informed decisions about crucial issues.

Target
Decision makers of logistics companies and transportation ecosystems in general.

Standard operating procedure
1. (description) The Executive Dashboard tracks data sent from the LSL app/reader. This information is meant for any personnel who need to see data about shipments or other events.
2. (description) The dashboard can organize this data into an ideal format which can be used to analyze events, create reports, and manage the data in a manner that will be useful for employees as actionable information.
3. (description) The employees can use the data not only for internal tracking, but also for negotiating issues with their vendors or clients, or any other usage. For example, an insurance company may dynamically decide to adjust (increase/decrease) the premium rates depending upon the incidents/events rates on a transportation route.
4. (description) Logistics companies can identify trends, enabling them to rectify problems.

### Embodiment 9

### Certified Electronic Warranty (CEW)

Abbreviations
ED—Executive Dashboard
IEM—Equipment Manufacturer
IoT—Internet of Things
NFC—Near Field Communication
EM—Equipment Manufacturer
LSL—Logistics Sensor Logger
SC—Sending Customer (customer of the trucking company shipping cargo to a Receiving Customer)
RC—Receiving customer (customer receiving the cargo sent by SC)
Label—shipping information used to process cargo
TC—Trucking Company
CC—Courier company
BL—Bill of Lading
LC—Large Company
SE—Small End-User
CNTC—Container-Manufacturer/Leasing/Owner company
SBS—Smart Bumper
SEU—shipping end user
SEC—Shipping end customer
CEW—Certified Electronic Warranty

The CEW is a novel system that accurately shows the history of usage of a warrantied product. This allows a quick resolution of disputes between the issuer of the warranty and the customer, if the product has been maintained within warranty limits as set in the warranty parameters of the SBS device.

CEW can create new streams of revenue by offering an electronic warranty on products. It works by simply attaching a Logistic Sensor Logger (LSL) device on the product; The LSL contains the CEW for the product. It is as easy as applying a sticker to the product that adheres to a variety of surfaces. In order to activate the warranty, the customer will use a reader which can include but is not limited to a phone or a tablet. Once the product is correctly registered into the warranty program, it can be easy to check to make sure no warranty violations have occurred when a problem is reported.

Another stream of revenue is a yearly contracted maintenance program that is useful for maintaining existing customers, increasing customer retention and loyalty.
Ship products with accurate knowledge about the quality of their trip
Quick access to the warranty providers and insurance agencies through electronic digital certificates
A Digital Warranty Certificate pinpoints how much damage occurred, when it occurred, and the location of the equipment when the incident happened.
Companies can use this to quickly resolve if the equipment is still covered by the warranty.
Support teams can use this information provided by the certificate to determine needed repairs to the equipment.
Companies can use the management of a Digital Warranty Certificate to improve the speed of resolution of equipment issues.
Companies using the management of a Digital Warranty Certificate to increase the efficacy of support teams.
Digital Warranty Certificates will help companies grow paid maintenance programs increasing company profits and ensuring customer loyalty.
Offer an electronic warranty for the life of the product to track damages and warranty violations
Assist support teams in understanding what might be causing issues

Target
Businesses offering warranties.

Standard operating procedure
1. (action) Companies may offer their customers a DWC for that piece of equipment which is tied to the life of the warranty.
2. (action) A LSL device is placed on the equipment.
3. (action) If a warranty claim is made, the LSL device is scanned with a reader, which issues a report detailing the events in the claim.
4. (action) The issuer of the warranty can determine if the damage falls within the coverage of their warranty.

We claim:

1. A field-reconfigurable secure apparatus to Quantify Efficacy of Transportation Systems comprising:
A plurality of sensors and
static or volatile storage for sensor readings and
input/output interface, and
unchangeable digital signature that is verifiable without trusted third-party.

2. The apparatus of claim 1 to provide an Electronic Warranty Certificate (EWC).

3. The apparatus of claim 1 to manage maintenance contracts.

4. The apparatus of claim 1 in a fixed or removable form factor, applied to, fastened or attached to a transportation medium.

5. The apparatus of claim 1 to detect and/or process and/or store and/or analyse events like vibration, shock, temperature, hygrometry, pressure, light, sound and other environmental activities and events.

6. The apparatus of claim 1 to monitor genetically-related transportation parameters/conditions, like ultraviolet light, oxidation, chlorination, nitration, and akylation, which may disturb or alter the genetic makeup of the vaccines.

7. The apparatus of claim 1 which uses wireless technologies like NFC/BLE/UWB/Zigbee as input-output interface for configuration of said apparatus and/or communication of data to/from said apparatus.

8. The apparatus of claim 1 used to dynamically reroute in-transit cargo of potentially damaged or perished goods.

9. The apparatus of claim 1 to algorithmically estimate geo-location of itself without using external location techniques.

10. The apparatus of claim 1 to use energy harvesting.

11. The system and methods to quantify efficacy of transportation systems, comprising:
a logging device comprising a plurality of sensors, and static or volatile storage for sensor readings, and input/output interface, and unchangeable digital signature that is verifiable without trusted third-party, and
a field-reconfigurable reader device to read data from said logging device and
interfaces for transmitting information and
medium to store said data, and
processor to generate reports.

12. The system of claim 11, wherein the Electronic Warranty Certificate (EWC) provides a history of the warrantied item.

13. The system of claim 11, to manage Maintenance Contracts.

14. The system of claim 11, to identify problem links/routes/areas and/or dynamically determine relevant parameters like risk analysis and insurance premium pertaining to the link.

15. The system of claim 11 to detect and/or process and/or store and/or analyze events like vibrations, shocks, temperature, hygrometry, pressure, light, sound and other environmental activities and events.

16. The system of claim 11 to monitor genetically-related transportation parameters/conditions which may disturb or alter the genetic makeup of vaccines/medicines, potentially causing unknown effects to recipients.

17. The system of claim 11, which uses wireless technologies like NFC/BLE/UWB/Zigbee as input-output interface for communication of data between components of said system.

18. The system of claim 11, used to dynamically reroute in-transit cargo of potentially damaged or perished goods.

19. The system of claim 11, using secured and/or encrypted authentication mechanisms (for example blockchain technology, non-fungible token NFT, or RSA).

20. The system of claim 11 adapted for real-time alert/notification.
